(19) United States
(12) Patent Application Publication
(10) Pub. No.: US 2007/0008987 A1
(43) Pub. Date: Jan. 11, 2007

(54) Capturing contacts via people near me

(75) Inventors: Todd R. Manion, Redmond, WA (US); Sandeep K. Singhal, Kirkland, WA (US); Ravi Rao, Redmond, WA (US)

Correspondence Address: MARSHALL, GERSTEIN & BORUN LLP (MICROSOFT), 233 SOUTH WACKER DRIVE, 6300 SEARS TOWER, CHICAGO, IL, 60606, US

(73) Assignee: MICROSOFT CORPORATION, Redmond, WA (US)

(21) Appl. No.: 11/175,951

(22) Filed: Jul. 6, 2005

(51) Int. Cl. H04J 3/02

(52) U.S. Cl. 370/462

(57) ABSTRACT

Users on a peer-to-peer network, particularly a local subnet or ad hoc wireless network, may publish first contact information to a graph or data store on the network. The first contact information may include a certificate with a public-key and a user identification, such as a peer name. Other users may discover the first contact information and use the first contact information to request additional information from the user. Data in the first contact information may also be “promoted” by adding the information to a trusted contacts database, allowing the user additional privileges. The user publishing the first contact information may be given the opportunity to approve or deny the request for additional information.

### BACKGROUND

In many client/server applications, the server acts as a connection point for sharing information, holding computer-based meetings, and storage of email addresses. The server acts as a host to various communication-oriented applications, such as email. However, in peer-to-peer networks, such servers may not be available, accessible, or even desirable. Particularly in the case of ad hoc wireless networks, it may be difficult, if not impossible, to discover or maintain the necessary contact information that would otherwise allow users to enjoy the benefit of the rich capabilities of peer-to-peer networking.

### SUMMARY

A user on a peer-to-peer network may publish enough information about himself or herself so they may be discovered and subsequently contacted. A second user, using the published information, may contact the user and request more detailed information. The user may then decide whether to share additional personal information. When information is shared, it may be added to the second user's personal database. The second user may choose to “promote” the user to a trusted contact. In so doing, a certificate including the user's public key infrastructure information may be added to a trusted user database maintained by the second user. This allows the user a higher level of access to the second user's computer, such as access to personal files, documentation, presentations, or computing resources and facilitates the transmission of encrypted or signed correspondence. By sharing contact information and promoting contacts to trusted contacts, a workgroup or similar community may take advantage of a rich set of features available in peer-to-peer networking, such as file sharing, instant messaging, data streaming, workgroup collaboration, etc.

### BRIEF DESCRIPTION OF THE DRAWINGS

FIG. 1 is a simplified and representative block diagram of a computer network;

FIG. 2 is a block diagram of a computer that may be connected to the network of FIG. 1;

FIG. 3 is a representation of a subnet of a computer network such as the network of FIG. 1;

FIG. 4, is a representation of a computer display showing a window displaying discovery of nearby users;

FIG. 5 is a representation of a computer display showing the window of FIG. 4 with a drop-down menu selection;

FIG. 6 is a method of publishing user information and responding to a request for additional contact information;

FIG. 7 is a method of discovering nearby users and adding contact information; and

FIG. 8 is a method of promoting a user to trusted status.

### DETAILED DESCRIPTION

Although the following text sets forth a detailed description of numerous different embodiments, it should be understood that the legal scope of the description is defined by the words of the claims set forth at the end of this disclosure. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. §112, sixth paragraph.

Much of the inventive functionality and many of the inventive principles are best implemented with or in software programs or instructions and integrated circuits (ICs) such as application specific ICs. It is expected that one of ordinary skill, notwithstanding possibly significant effort and many design choices motivated by, for example, available time, current technology, and economic considerations, when guided by the concepts and principles disclosed herein will be readily capable of generating such software instructions and programs and ICs with minimal experimentation. Therefore, in the interest of brevity and minimization of any risk of obscuring the principles and concepts in accordance to the present invention, further discussion of such software and ICs, if any, will be limited to the essentials with respect to the principles and concepts of the preferred embodiments.

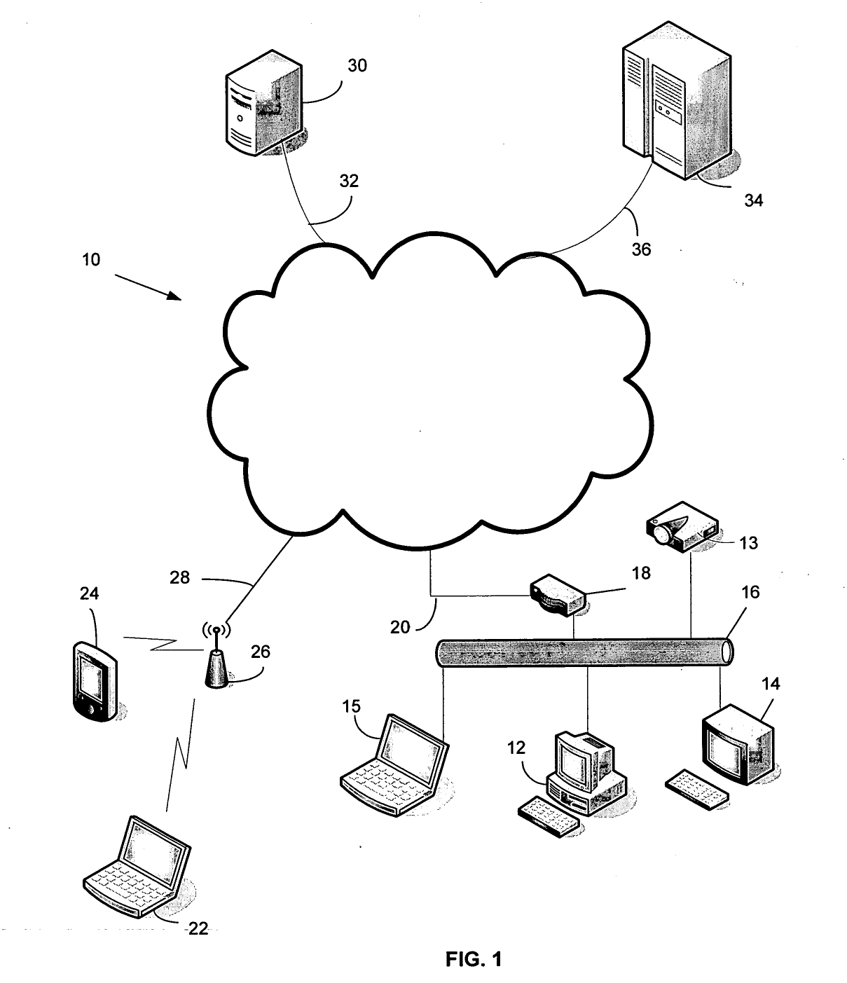

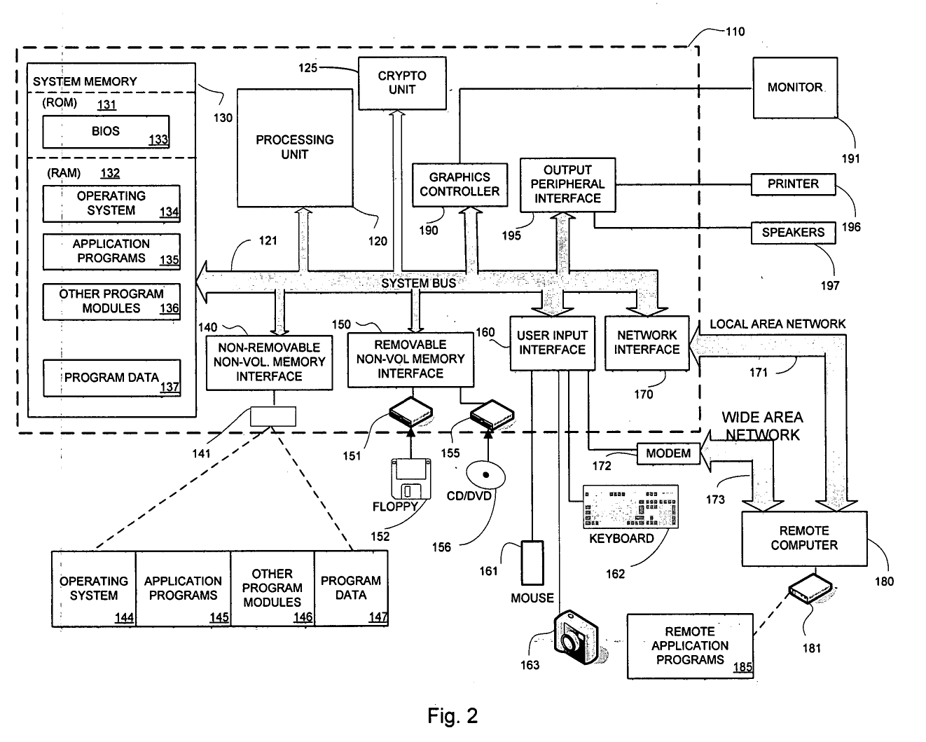

FIGS. 1 and 2 provide a structural basis for the network and computational platforms related to the instant disclosure.

FIG. 1 illustrates a network 10. The network 10 may be the Internet, a virtual private network (VPN), or any other network that allows one or more computers, communication devices, databases, etc., to be communicatively connected to each other. The network 10 may be connected to a personal computer 12, a computer terminal 14, and a laptop 15 via an Ethernet 16 and a router 18, and a landline 20. The Ethernet 16 may be a subnet of a larger Internet Protocol network. Other networked resources, such as a projector 13, may also be supported via the Ethernet 16 or another data network. On the other hand, the network 10 may be wirelessly connected to a laptop computer 22 and a personal data assistant 24 via a wireless communication station 26 and a wireless link 28. Similarly, a server 30 may be connected to the network 10 using a communication link 32 and a mainframe 34 may be connected to the network 10 using another communication link 36. The network 10 may be useful for supporting peer-to-peer network traffic.

FIG. 2 illustrates a computing device in the form of a computer 110. Components of the computer 110 may include, but are not limited to a processing unit 120, a system memory 130, and a system bus 121 that couples various system components including the system memory to the processing unit 120. The system bus 121 may be any of several types of bus structures including a memory bus or memory controller, a peripheral bus, and a local bus using any of a variety of bus architectures. By way of example, and not limitation, such architectures include Industry Standard Architecture (ISA) bus, Micro Channel Architecture (MCA) bus, Enhanced ISA (EISA) bus, Video Electronics Standards Association (VESA) local bus, and Peripheral Component Interconnect (PCI) bus also known as Mezzanine bus.

The computer 110 may also include a cryptographic unit 125. Briefly, the cryptographic unit 125 has a calculation function that may be used to verify digital signatures, calculate hashes, digitally sign hash values, and encrypt or decrypt data. The cryptographic unit 125 may also have a protected memory for storing keys and other secret data. In addition, the cryptographic unit 125 may include an RNG (random number generator) which is used to provide random numbers. In other embodiments, the functions of the cryptographic unit may be instantiated in software or firmware and may run via the operating system or on a device.

Computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes volatile and nonvolatile, removable and non-removable media implemented in any method or technology for storage of information such as computer readable instructions, data structures, program modules or other data. Computer storage media includes, but is not limited to, RAM, ROM, EEPROM, FLASH memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, radio frequency, infrared and other wireless media. Combinations of any of the above should also be included within the scope of computer readable media.

The system memory 130 includes computer storage media in the form of volatile and/or nonvolatile memory such as read only memory (ROM) 131 and random access memory (RAM) 132. A basic input/output system 133 (BIOS), containing the basic routines that help to transfer information between elements within computer 110, such as during start-up, is typically stored in ROM 131. RAM 132 typically contains data and/or program modules that are immediately accessible to and/or presently being operated on by processing unit 120. By way of example, and not limitation, FIG. 2 illustrates operating system 134, application programs 135, other program modules 136, and program data 137.

The computer 110 may also include other removable/non-removable, volatile/nonvolatile computer storage media. By way of example only, FIG. 2 illustrates a hard disk drive 141 that reads from or writes to non-removable, nonvolatile magnetic media, a magnetic disk drive 151 that reads from or writes to a removable, nonvolatile magnetic disk 152, and an optical disk drive 155 that reads from or writes to a removable, nonvolatile optical disk 156 such as a CD ROM or other optical media. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like. The hard disk drive 141 is typically connected to the system bus 121 through a non-removable memory interface such as interface 140, and magnetic disk drive 151 and optical disk drive 155 are typically connected to the system bus 121 by a removable memory interface, such as interface 150.

The drives and their associated computer storage media discussed above and illustrated in FIG. 2, provide storage of computer readable instructions, data structures, program modules and other data for the computer 110. In FIG. 2, for example, hard disk drive 141 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a keyboard 162 and cursor control device 161, commonly referred to as a mouse, trackball or touch pad. A camera 163, such as web camera (webcam), may capture and input pictures of an environment associated with the computer 110, such as providing pictures of users. The webcam 163 may capture pictures on demand, for example, when instructed by a user, or may take pictures periodically under the control of the computer 110. Other input devices (not shown) may include a microphone, joystick, game pad, satellite dish, scanner, or the like. These and other input devices are often connected to the processing unit 120 through an input interface 160 that is coupled to the system bus, but may be connected by other interface and bus structures, such as a parallel port, game port or a universal serial bus (USB). A monitor 191 or other type of display device is also connected to the system bus 121 via an interface, such as a graphics controller 190. In addition to the monitor, computers may also include other peripheral output devices such as speakers 197 and printer 196, which may be connected through an output peripheral interface 195.

The computer 110 may operate in a networked environment using logical connections to one or more remote computers, such as a remote computer 180. The remote computer 180 may be a personal computer, a server, a router, a network PC, a peer device or other common network node, and typically includes many or all of the elements described above relative to the computer 110, although only a memory storage device 181 has been illustrated in FIG. 2. The logical connections depicted in FIG. 2 include a local area network (LAN) 171 and a wide area network (WAN) 173, but may also include other networks. Such networking environments are commonplace in offices, enterprise-wide computer networks, intranets and the Internet.

When used in a LAN networking environment, the computer 110 is connected to the LAN 171 through a network interface or adapter 170. When used in a WAN networking environment, the computer 110 typically includes a modem 172 or other means for establishing communications over the WAN 173, such as the Internet. The modem 172, which may be internal or external, may be connected to the system bus 121 via the input interface 160, or other appropriate mechanism. In a networked environment, program modules depicted relative to the computer 110, or portions thereof, may be stored in the remote memory storage device. By way of example, and not limitation, FIG. 2 illustrates remote application programs 185 as residing on memory device 181.

The communications connections 170 172 allow the device to communicate with other devices. The communications connections 170 172 are an example of communication media. The communication media typically embodies computer readable instructions, data structures, program modules or other data in a modulated data signal such as a carrier wave or other transport mechanism and includes any information delivery media. A “modulated data signal” may be a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Computer readable media may include both storage media and communication media.

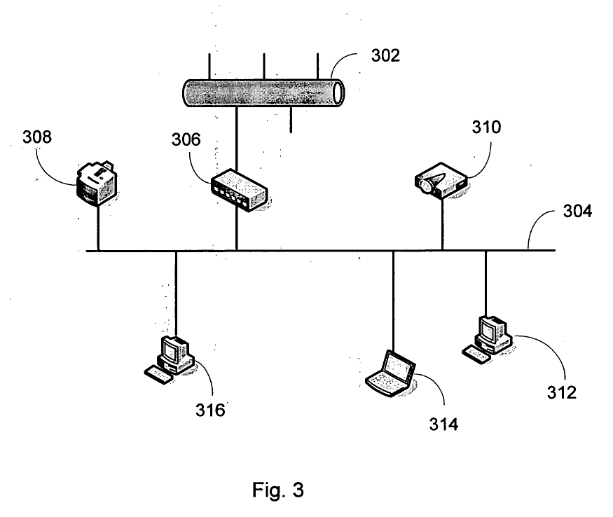

FIG. 3 depicts an exemplary computer network, that may be similar to or coupled to the network 10 of FIG. 1. A data network 302, for example an Ethernet network, may have a subnet 304 coupled to the data network 302 by a bridge or router 306. Network devices may be coupled to the subnet 304. In this exemplary illustration, a printer 308 and a network-aware projector 310 are present on the subnet 304. Workstations or computers 312 314 and laptop 316 are also present on the subnet 304.

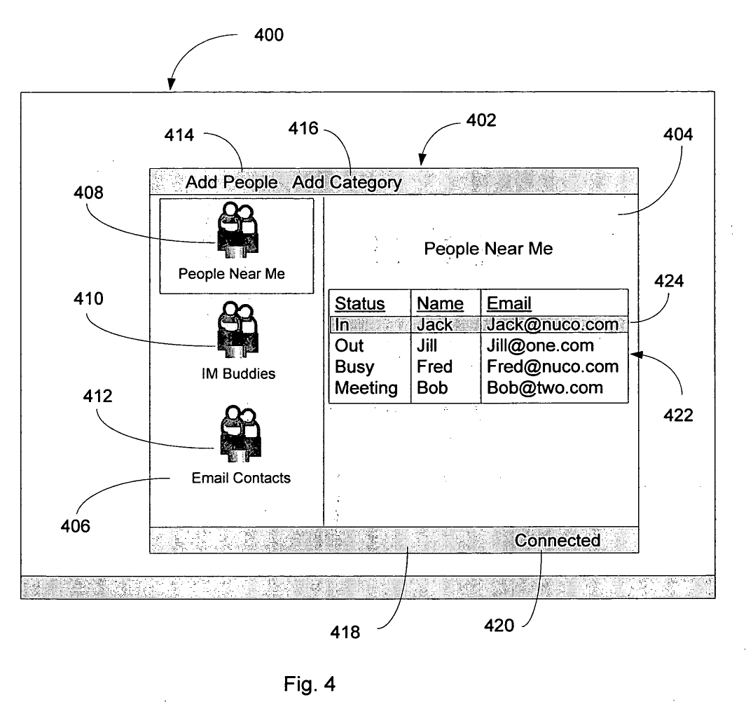

FIG. 4 shows an exemplary display screen 400, such as a computer display or monitor 191. A contact manager 402 has a pane 404 for displaying contact details and a pane 406 for displaying contact categories. The icon for People Near Me 408 is shown selected, with other exemplary icons IM Buddies 410 and Email Contacts 412. The contact manager 402 may also include a menu bar 414, shown having an Add People selection 414 and an Add Category selection 416. The contact manager 402 may also have a status bar 418, shown having a ‘Connected’ message 420.

Because the People Near Me icon 408 is selected in the categories pane 406, those users who have registered on the local subnet, or another visible network, such as an ad hoc wireless network, may be displayed in sub-pane 422. The user list in sub-pane 422 may apply alternative metrics, such as physical location or GPS coordinates, to filter or identify “nearby” users. In the embodiment shown, the sub-pane 422 gives status, name, and an email address for each person found. Additional information may be available as well, or in different combinations from that shown. In one embodiment, information about each user may include a self-signed certificate including a public key for use in a public key infrastructure (PKI) system. As shown in FIG. 4, the information corresponding to user “Jack” 424 is selected.

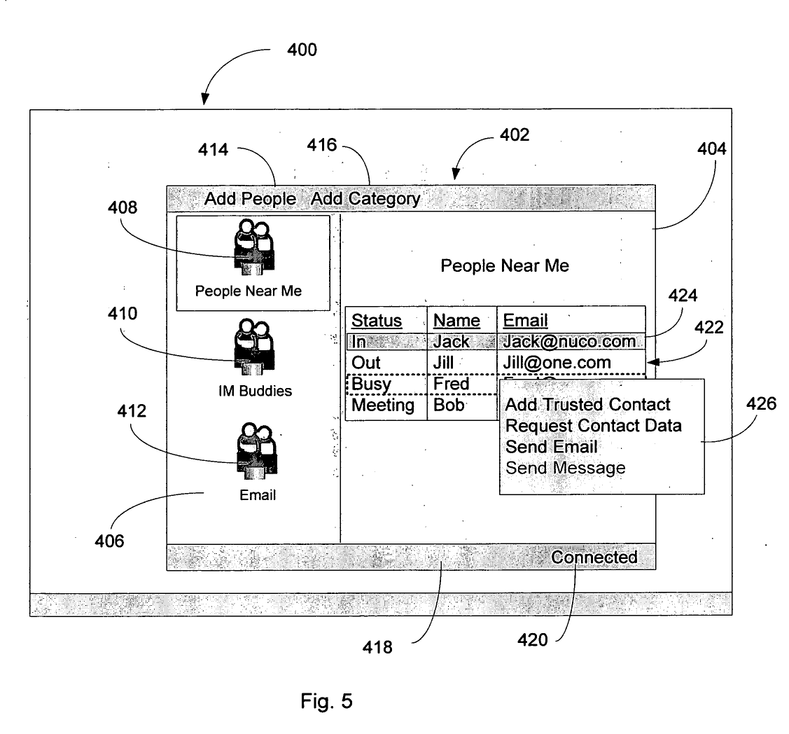

FIG. 5 shows the exemplary display screen 400 of FIG. 4 with the addition of a drop-down menu 426 in the contact manager 402. The drop-down menu 426 may be selected, in one embodiment, by right clicking on the selected user name, in this case, “Jack.” The menu selections shown depict adding the contact as a trusted contact, sending a request to the user for additional contact data, and sending an email. The menu selection for sending a message, such as an IM message, is grayed out because an IM contact address or screen name may not be available. To request IM contact information, a user may select the request contact data menu item, causing the application to send a request to Jack for that and/or other information.

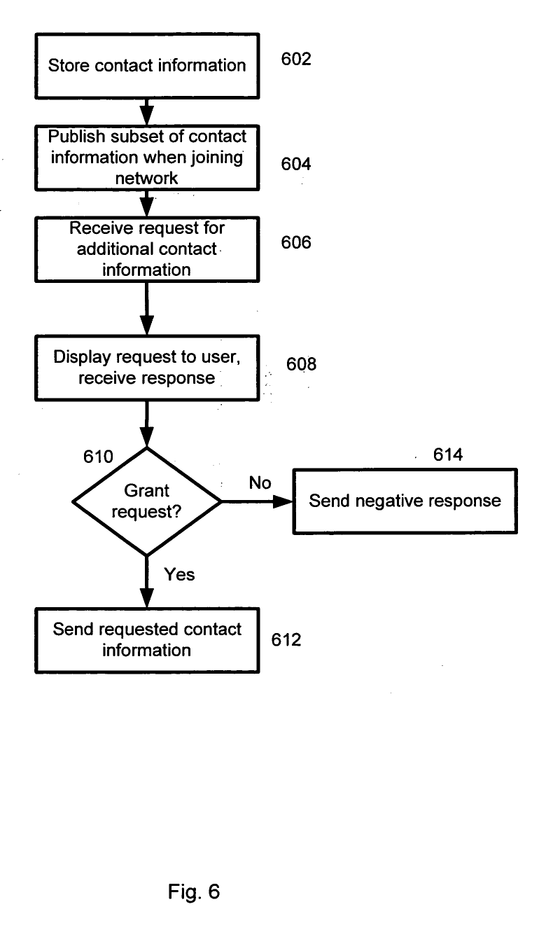

In FIG. 6 a method of publishing user information and responding to a request for additional contact information is discussed and described. A user may store 602 contact information, such as an email address, an IM screen name, an IP address or network endpoint information. The contact information may contain additional personal data, for example, workgroup information, status details (busy, meeting, lunch), or personal information, such as home address, home phone number, birthday or mood. Network endpoint information may include an IP address and port number or hostname and port number. During or after joining a peer-to-peer network, such as subnet 304 of FIG. 3, the user may choose to publish 604 a subset of his or her full contact information to allow them to be discovered by, or to be visible to, others on the network. In one embodiment, such as a highly trusted environment, the full set of contact information may be published initially.

The data published may include just a public key, or a certificate having a public key and a peer name. The peer name may be used by others to establish communication with the user in conjunction with a peer name resolution protocol (PNRP). The certificate may be self-signed, that is, encrypted with the user's own private key. The certificate may also be signed via a certificate authority (CA) and carry a full trust chain, but in many applications, trust of the public key or the self-signed certificate may be inherent due to the nature of the workgroup or the ability for users to access the particular subnet. However, in some environments, such as an airport or a coffee shop wireless LAN, there may be little or no trust inherent among users.

After being discovered by others on the network (see below), the user may receive 606 a request from another user for contact information beyond that published already. For example, additional information may include phone number, cell phone number, email address, home address, screen name, or personal data, such as birthday. An application managing contacts, such as the application shown in FIG. 4, may process the request and display 608 a message to the user requesting approval to share contact information with the requesting party. When the user agrees to share contact information, the ‘yes’ branch from block 610 may be followed. All or some of the request and contact information may be sent 612 to the requesting party. When the user does not agree to share the contact information, the ‘no’ branch from block 610 may be followed and the request may die or a negative response may be sent 614 to the requesting party. The user may set policies that cause a default action to be taken in response to decision block 610; for example, the user may choose to automatically share data to all requesting users or to automatically deny all requests for additional data.

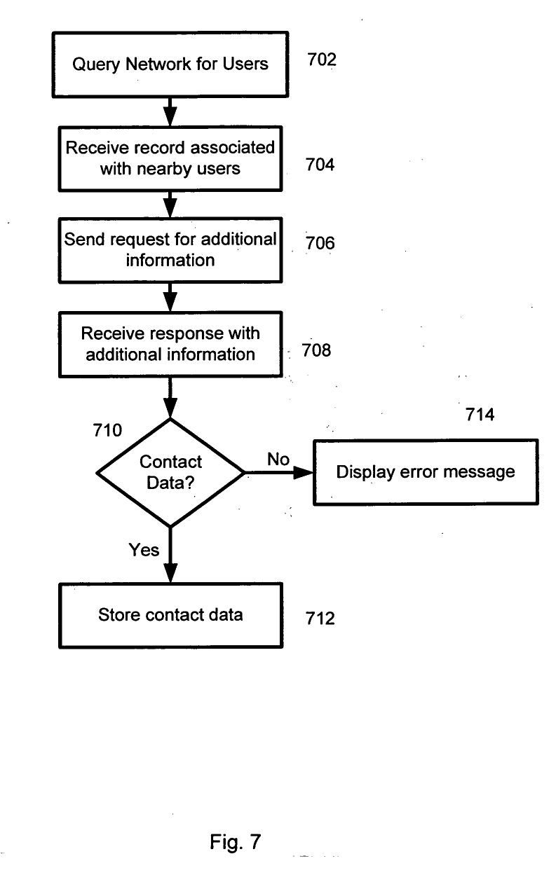

FIG. 7 is a method for discovering users on a local network. A query may be made 702 to a graph (centralized or distributed data store) or via a broadcast or multicast discovery protocol on the subnet having user registration information for those users who have published contact information to the peer-to-peer network. A response to the query may be received 704 and the user information may be stored, or stored and displayed by an application such as the contact manager 402 shown in FIG. 4.

A user may examine the contact information received and request 706 additional contact information, for example, using the drop-down menu 426 of FIG. 5. When a response is received 708 its content may be examined. When the response includes the requested additional contact information, the ‘yes’ branch from block 710 may be taken and the received contact information stored 712 in an appropriate contact manager, such as contact manager 402, or another address book or data store. When the received data does not include contact information, for example, when the request 706 was denied by the user, the ‘no’ branch from block 710 may be taken and an error message may be displayed 714.

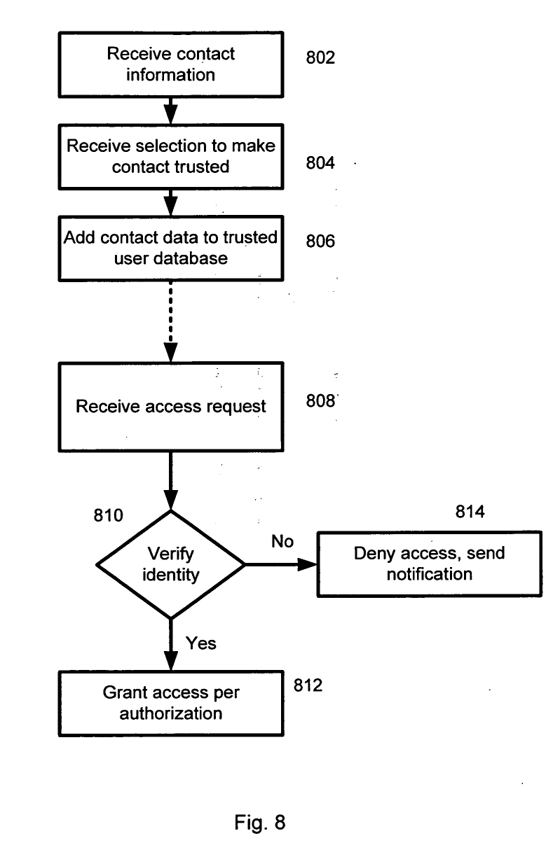

FIG. 8 is a method for receiving contact information and promoting a contact to trusted status. As discussed above, a user may receive 802 contact information in the course of a query to a network data store or graph of nearby users. The user may choose 804 to make the contact a trusted contact. A user interface, such as that described with respect to FIG. 5, may be used to receive instructions to promote a contact to a trusted contact. The user interface program may, through a series of application program interface (API) calls, such as calls to an add-contact API and subsequently to a Cryptographic API (CAPI), add the public key or the self-signed certificate, described above, to a Trusted People Store where trusted contact information may be maintained.

Subsequently, a trusted contact may request access to the user's computer, or a resource associated with his or her computer. After the request is received 808, verification of the requestor's identity may be made through ordinary cryptographic means, for example, decrypting the request, or a portion of the request, using the public key from the certificate stored in the Trusted People Store. The certificate may also be used in the course of data encryption or data signing, as is well established in the prior art. When the identity is verified, the ‘yes’ branch from block 810 may be taken and access granted 812 to the requesting party. Such access may include access to file stores, computing resources, or peripherals. If the identity is not verified the ‘no’ branch from block 810 may be taken to block 814 and the access request denied. Optionally, a notification may be sent to the requesting party indicating that the request was denied.

Although the forgoing text sets forth a detailed description of numerous different embodiments of the invention, it should be understood that the scope of the invention is defined by the words of the claims set forth at the end of this patent. The detailed description is to be construed as exemplary only and does not describe every possibly embodiment of the invention because describing every possible embodiment would be impractical, if not impossible. Numerous alternative embodiments could be implemented, using either current technology or technology developed after the filing date of this patent, which would still fall within the scope of the claims defining the invention.

Thus, many modifications and variations may be made in the techniques and structures described and illustrated herein without departing from the spirit and scope of the present invention. Accordingly, it should be understood that the methods and apparatus described herein are illustrative only and are not limiting upon the scope of the invention.

We claim:

1. A method of acquiring contact information related to users on a peer-to-peer network comprising:
determining the presence of a user on a peer-to-peer network;
sending a request message to the user, the request message comprising a request for contact information;
receiving contact information from the user, the contact information comprising information corresponding to the user; and
adding the contact information to a local contact database.

2. The method of claim 1, wherein determining the presence of the user further comprises at least one of querying a user graph of a peer-to-peer network or use of a discovery protocol.

3. The method of claim 2, further comprising displaying information associated with the user in a pane of a display window.

4. The method of claim 3, wherein the displaying information associated with the user further comprises displaying public data about the user.

5. The method of claim 3, wherein information associated with the user further comprises displaying status information about the user.

6. The method of claim 1, wherein the local contact database comprises at least one of an address book, a messaging application, or a meeting application.

7. The method of claim 1, wherein determining the presence of a user from the user comprises receiving a public key corresponding to the user.

8. The method of claim 7, further comprising adding the public key to a database comprising trusted contacts.

9. The method of claim 8, wherein adding the public key to the database comprising trusted contacts grants additional access privileges to the user.

10. A method for distributing contact information for users on a peer-to-peer network comprising:
storing first and second contact information corresponding to a user;
publishing the first contact information;
receiving a request from a requesting party over a peer-to-peer network for the second contact information;
displaying a query to the user requesting authorization to share the contact information with the requesting party;
receiving a response to the query; and
sending the second contact information to the requesting party when the response to the query is affirmative.

11. The method of claim 10, further comprising:
generating a certificate comprising a public key and user identification information; and
providing the certificate when publishing the first contact information.

12. The method of claim 11, wherein generating the certificate further comprises generating a self-signed certificate comprising a public key and user identification information.

13. The method of claim 10, further comprising verifying an identity of the user at a remote peer using the certificate.

14. A computer adapted for a operation in a peer-to-peer network, the computer comprising:
a processing unit for executing instructions;
a networking device coupled to processing unit for coupling data transmitted between the computer and the peer-to-peer network;
a memory for storing computer executable instructions, coupled to the processing unit, the computer executable instructions for executing a method comprising:
obtaining an identity record for a user publishing contact information on a subnet of the peer-to-peer network;
displaying information from the identity record;
sending a request message to the user, the request message comprising a request for additional contact information;
receiving a response to the request message;
adding the additional contact information to a local contact database if the response includes the additional contact information.

15. The computer of claim 14, further comprising extracting addressing data from the identity record, wherein the addressing data is used for sending the request message to the user.

16. The computer of claim 14, wherein the identity record comprises at least one of a certificate or information corresponding to presence on the subnet.

17. The computer of claim 14, wherein obtaining the identity record for a user further comprises at least one of a query of a meeting graph or use of a discovery protocol.

18. The computer of claim 14, wherein displaying information from the identity record further comprises displaying in a pane of a display window at least one of public data about the user, contact information for the user, and status information about the user.

19. The computer of claim 14, further comprising putting data from a public-key infrastructure certificate into a trusted contacts database.

20. The computer of claim 19, further comprising verifying user identity using the public key infrastructure certificate and granting the user privileges corresponding to the user identity.
